(19) United States
(12) Patent Application Publication
(10) Pub. No.: US 2006/0016737 A1
(43) Pub. Date: Jan. 26, 2006

(54) Return station for refundable or borrowed objects

(75) Inventor: Sven-Erik Carlson, Herrliberg (CH)

Correspondence Address: NOTARO AND MICHALOS, 100 DUTCH HILL ROAD, SUITE 110, ORANGEBURG, NY, 10962-2100, US

(73) Assignee: TRION AG, Volketswil (CH)

(21) Appl. No.: 10/526,179

(22) PCT Filed: Aug. 26, 2003
(86) PCT No.: PCT/CH03/00576

§ 371 Date: Jul. 5, 2005

(30) Foreign Application Priority Data
Sep. 16, 2002 (EP) 02 020 738.7

(51) Int. Cl. B07C 5/00; G06K 9/00

(52) U.S. Cl. 209/584

(57) ABSTRACT

An arrangement and method for acceptance or return of objects for a deposit and/or for a lending system has an acceptance zone for intake of the object, a reading device to ascertain the association of the object with a specific deposit or a lending system, a transporting device for transporting the object and at least one blocking member through which, upon positive ascertainment by the reading device, the object is transported.

The present invention relates to an arrangement for the acceptance of objects for which a deposit has been paid or can be paid and/or objects which pertain to a lending system according to the preamble of claim 1, use of the arrangement as well as a method for the acceptance of objects for which a deposit has been paid or can be paid and/or of objects that pertain to a lending system.

When accepting objects for which a deposit has been paid or can be paid as well as also objects that pertain to a lending system, the problem is encountered that objects which have already been accepted are removed without authorization. In the case of redeemable objects this occurs, as a rule, in order to receive payment of the redeemed deposit a second time. In the case of objects of lending systems, such as for example of library books, videos, etc., to remove these in an unauthorized and improper way since the object has already been registered as having been returned.

In known systems, such as in particular library lending systems, such as for example that described in WO 00/64974, as a rule, great attention is paid to the acquisition of the check-out and the lending and the acceptance, the registration of users, etc. but not to improper actions during the return or acceptance of the objects.

The arrangement described in WO 99/64974 for the acceptance of books in libraries, for example, is simple to manipulate, i.e. for example by tying a string to the object and pulling the object back after it has been registered, the user can remove its object in simple manner although the object has been registered as having been returned.

It is understood that in deposit redemption systems the problematic is analogous, where for example bottles or other receptacles, for which a deposit has been paid, can simply be removed again after their return in order to enter them again into a the return arrangement. In this way the deposit can be cashed several times for one and the same object, which, of course, represents improper use.

The present invention therefore has as its aim to propose an arrangement or a facility which takes into account the above described problematic and by means of which improper actions during the return or acceptance of objects of deposit systems or lending systems can largely be avoided. A further aim of the present invention comprises making possible rapid and efficient sorting of the returned objects.

A further aim comprises making possible the rapid acquisition of the return authorization or the speedy completion of transactions with a person returning an object.

The invention proposes an arrangement according to the wording of, in particular, claim 1.

It is proposed that the arrangement according to the invention for the acceptance of objects for which a deposit had been paid or can be paid and/or of objects pertaining to a lending system, which are provided with at least one at least readable identification code, characterized by a receiving station or a receiving zone for the intake or positioning of the object to be accepted by a consumer or a user returning the object. Further provided is at least one reading device provided to ascertain the association of the object with a specific deposit or lending system. Further provided is a transporting means which is operationally connected with said reading device such that, upon the position ascertainment of the association of the object, the transporting means is activated in order to transport the object away. Lastly is provided a blocking member through which the object is transported once the association of the object has been positively ascertained.

Consequently, if the reading device has not found any association of the object placed into the accepting station, the transporting means is not even activated or the object is transported to a location for non-associated objects, whereby neither a deposit redemption nor the return of the object is brought about or registered, respectively.

At the blocking member are preferably provided means in order to at least impede the backward movement of the object after it has passed through. Supplementally or alternatively, it is also possible to provide monitoring means at the blocking member to detect the backward movement of the object.

Both measures are suited to prevent said improper actions in order to prevent, for example, the consumer returning the object or the user of the lending system from pulling the object back by means of a string or another suitable means.

The monitoring means can be, for example, at least one position sensor, which indicates whether an object is located in the proximity of the blocking member or the direction in which the object is moved.

A further identification sensor is preferably provided for the identification of the accepted object in order to acquire, in the case of a redeemable object, for example the corresponding deposit amount or, in the case of a lending system, to register the acceptance of the object and optionally the object itself.

According to one embodiment variant it is possible that the identification sensor(s) and the reading device are identical or are disposed in one and the same structural component.

According to a further embodiment variant, it is possible that the reading device is disposed in front of the blocking member and the identification sensor(s) are disposed behind the blocking member.

Again, according to a further embodiment variant, it is possible that the identification sensor(s) include additionally a writing device, in order to change optionally data on a code or label, such as for example an RFID label (RFID=Radio Frequency identification Data), located on or integrated in an object, and/or to transmit data to this code or label.

For reading, acquiring and/or transmitting data, the reading device, the identification sensor(s) and the writing device operate preferably in the radio frequency range.

Often the objects accepted by an automatic return machine are to be sorted, for example according to material, color, type or some other criteria. The goal is therefore to ascertain how each object is to be sorted in order subsequently to carry out the corresponding sorting. For this reason the invention proposes further to connect the automatic return machine or the acceptance station electrically and/or logically with a succeeding sorting facility. For each accepted object, this sorting facility receives the specifications, for example from the accepting station, in order to assign the object to an appropriate sorting path. Stated differently, the appropriate sorting path is preferably automatically activated when the particular object has reached the corresponding site in the sorting facility or on the sorting path.

The acquisition of the objects and their position to make possible the correct sorting can take place by means of the several sensor types. If, for example, information about an object is stored on its RFID label, be that object a book, a CD, a video, etc., it is for example possible to dispose an RFID reader on each sorting path in order to determine, to acquire or to detect the object or its position. However, according to a further embodiment variant, it is also possible to determine position and object by means of photosensors and/or position encoders, for example on the driving motor of a conveyor belt.

Proposed is for example that the objects are sorted out by means of a pivot arm, guidance, lever arm, etc. at the particular assigned location of the sorting facility or on the correct sorting path. Especially preferred is the proposal of a tilt sorter unit disposed in cascade, i.e. the sorters are placed in a series arrayed one after the other in succession. The tilt sorters are preferably electrically and logically connected with one another and are electrically and/or logically drivable through the automatic return machine, such as for example the accepting station. A preferred embodiment variant of the tilt sorter proposed according to the invention will be explained in further detail in the following with reference to the enclosed figures.

In the arrangement defined according to the invention for the acceptance of objects it can be important that the objects with respect to return authorization must be acquired rapidly or that speedy completion of transactions with a person returning an object is made possible. This can be made difficult in particular when an automatic acceptance machine or an arrangement according to the invention for each entered object must fetch information from an external data base and must interpret this information, which in the event of poor response times in the electronic data processing network, during system failure or temporary connection difficulties can lead to unreasonable waiting times for the customer.

For this reason, the invention further proposes that at the arrangement or acceptance station a data base is provided, which for example can periodically download information from the external data base regarding all objects in the system. It is in this case possible to access the local data base in the acceptance arrangement in off-line mode. If necessary, it is possible to verify virtually instantaneously whether or not an object is authorized to be accepted and the way in which the sorting has to be carried out, etc.

Further preferred embodiment variants of the arrangement are characterized in the dependent claims.

The arrangement defined according to the invention is in particular suitable for deposit redemption systems, for example of consumer items, such as bottles, containers, bowls, crates, etc., for which a deposit had been paid, but also for lending systems such as for example libraries for the lending of books, CDs, computer games, videos, magazines and the like.

Reading as well as optionally also writing preferably takes place in the radio frequency range, the objects to be identified being preferably provided with a so-called RFID label or tag.

Lastly, a method is proposed for the acceptance of objects for which a deposit has been paid or can be paid and/or of objects pertaining to a lending system, which are provided with at least one at least readable identification code according to the wording of claim 28.

Further preferred methods and uses of the arrangement according to the invention are characterized in subclaims and dependent claims.

In the following the invention will be explained in further detail by example and with reference to the enclosed figures. In the drawing depict:

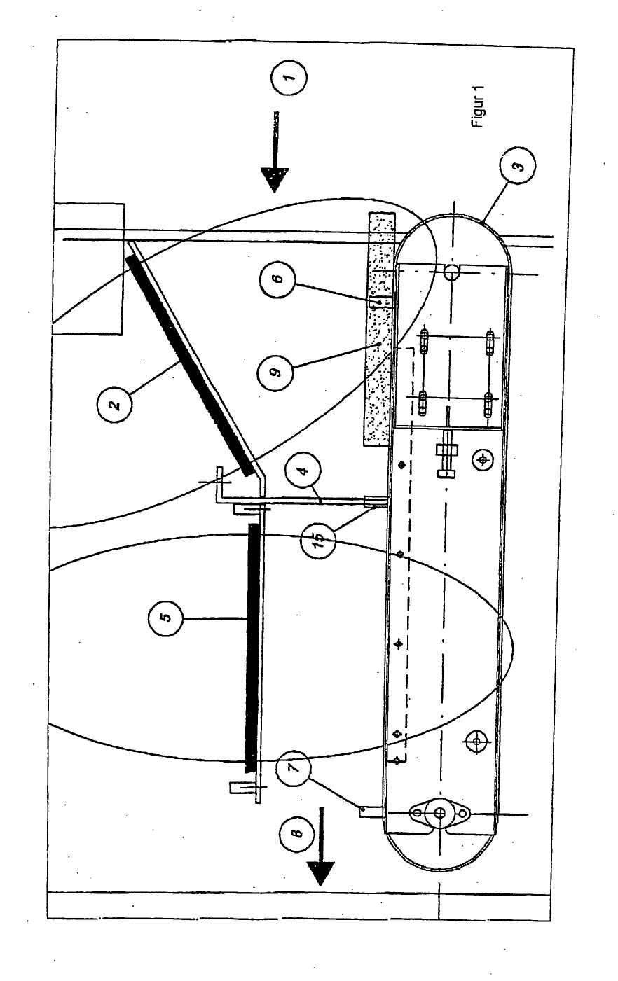

FIG. 1 schematically in longitudinal section an arrangement according to the invention,

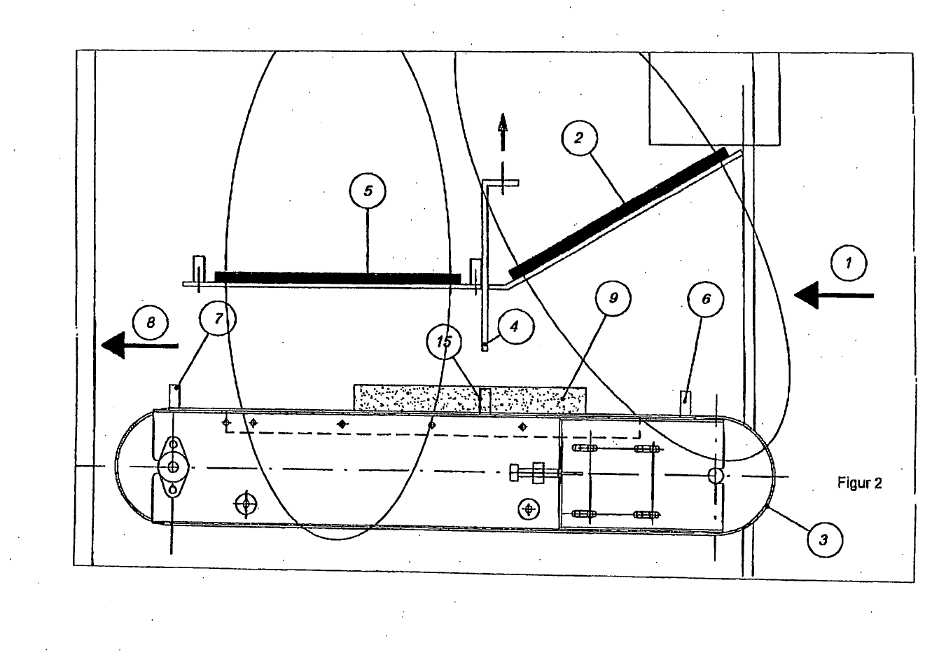

FIG. 2 the arrangement of FIG. 1 with an object located in the blocking zone,

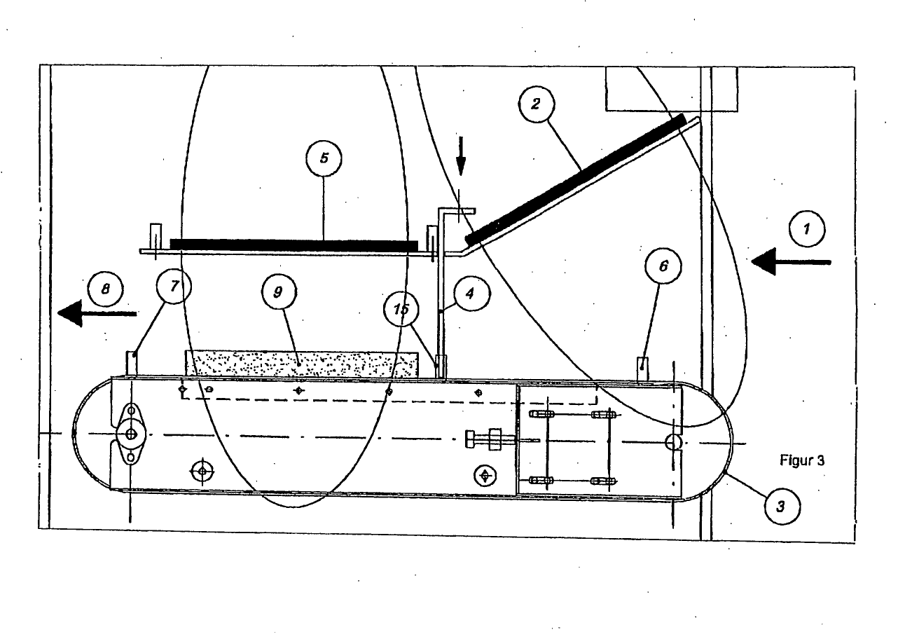

FIG. 3 the arrangement of FIGS. 1 and 2 with an object after it has passed through the blocking member,

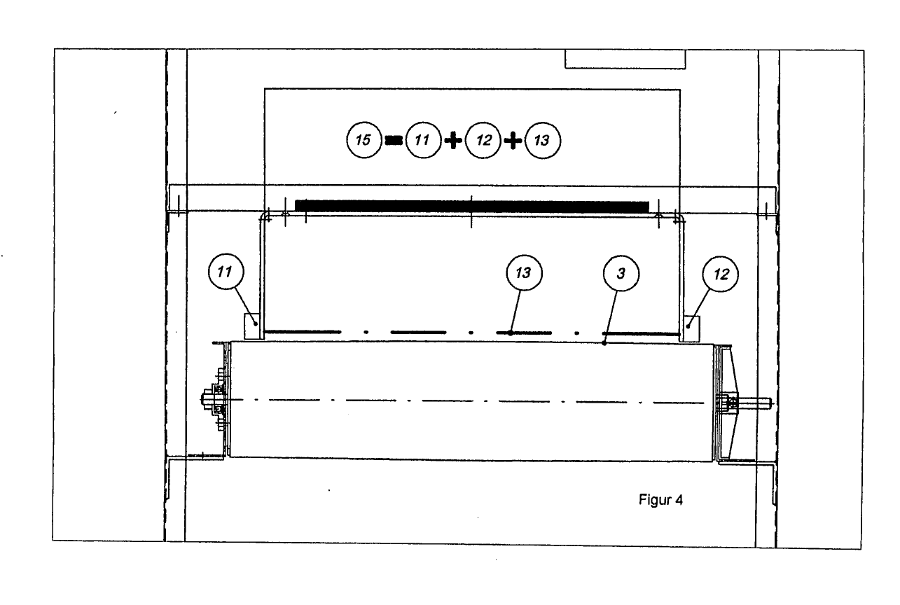

FIG. 4 schematically in cross section with reference to the arrangement of FIGS. 1 to 3 a feasible embodiment variant of the blocking member,

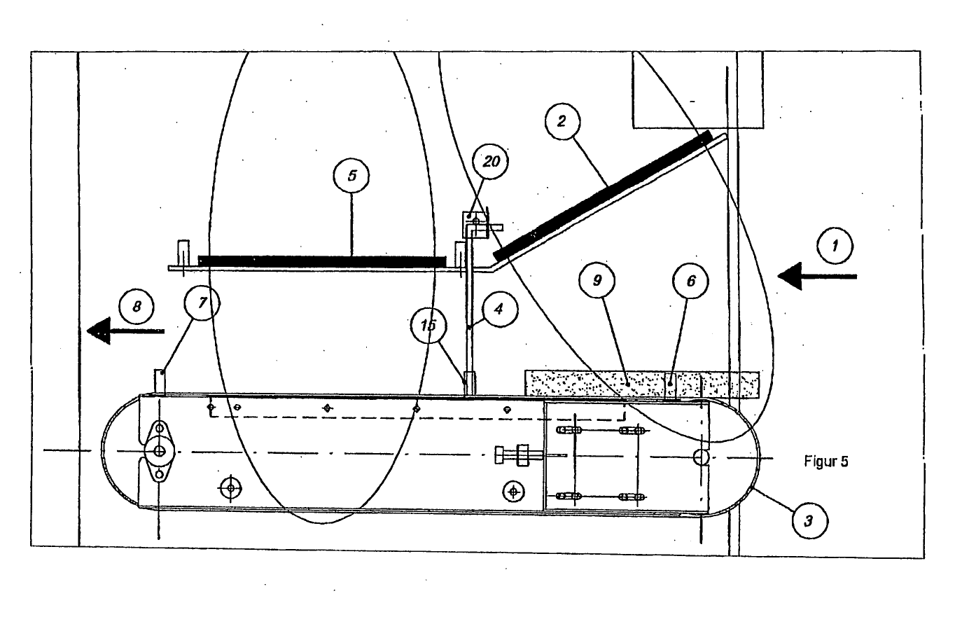

FIG. 5 a further embodiment variant of the arrangement according to FIG. 1, comprising a latching means on the blocking member,

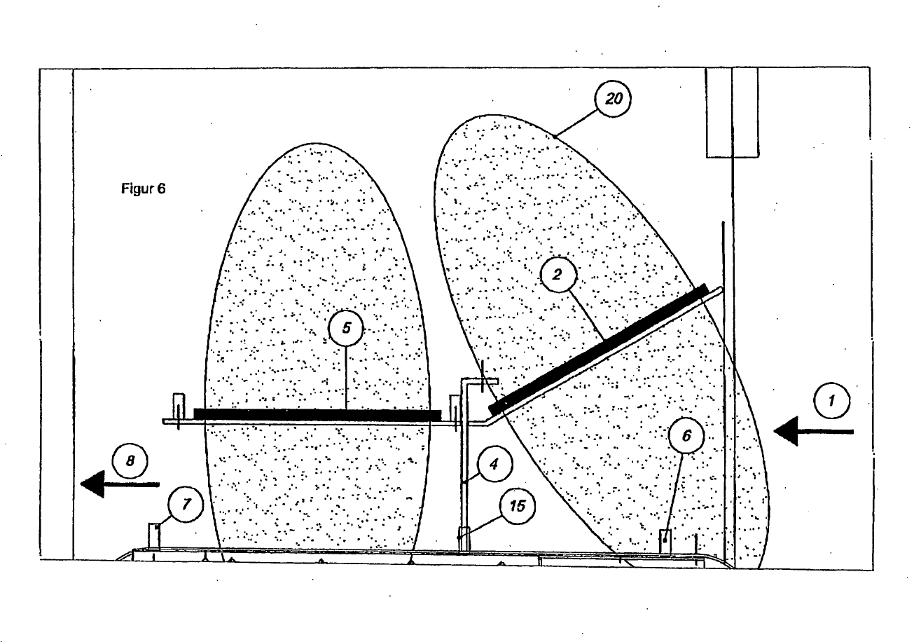

FIG. 6 again, a further embodiment variant of the arrangement according to the invention,

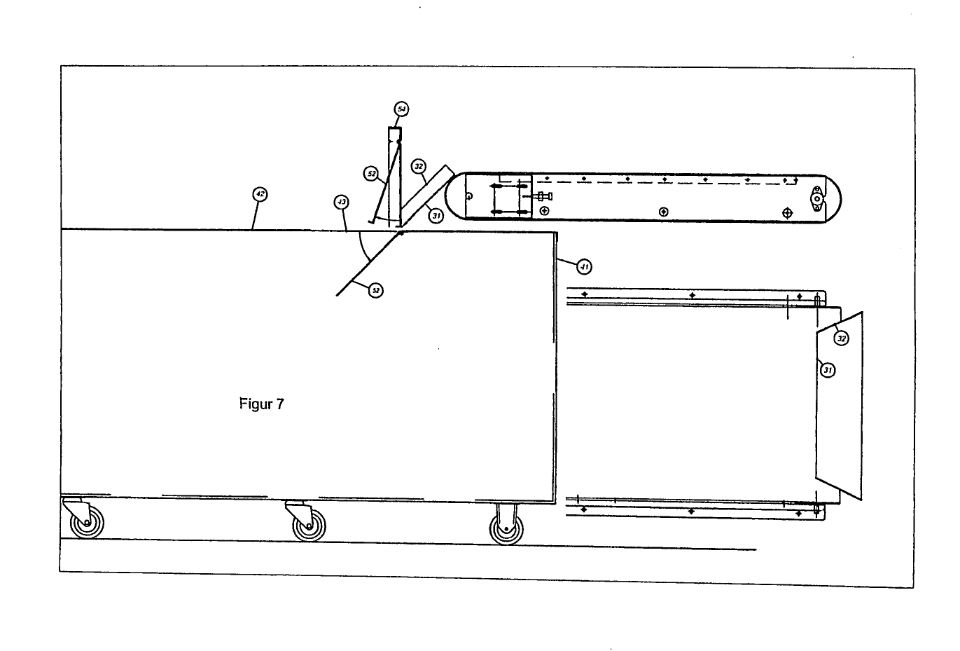

FIGS. 7 to 9 shown schematically feasible devices for the prevention of impermissible manipulations during the return of objects,

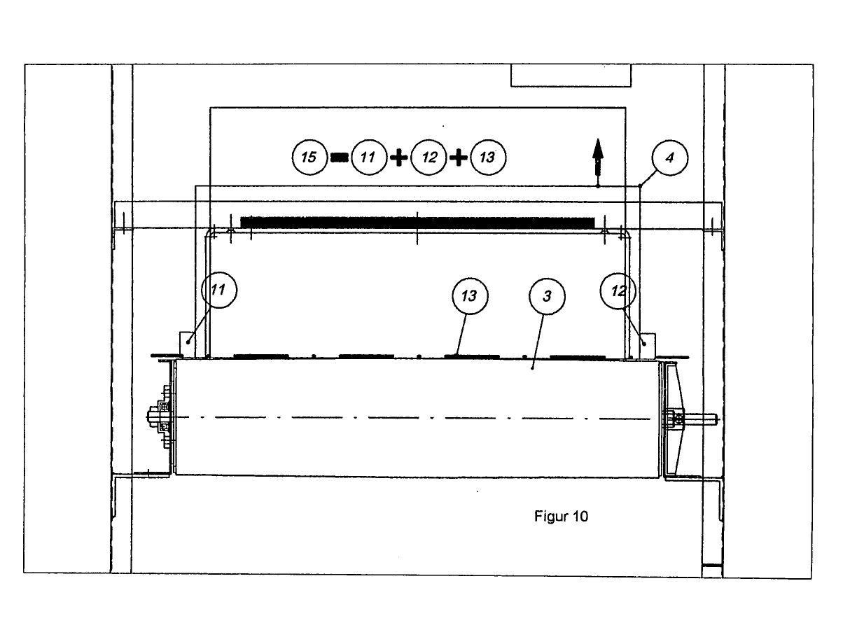

FIG. 10 a further embodiment variant of the blocking member depicted analogously to FIG. 4,

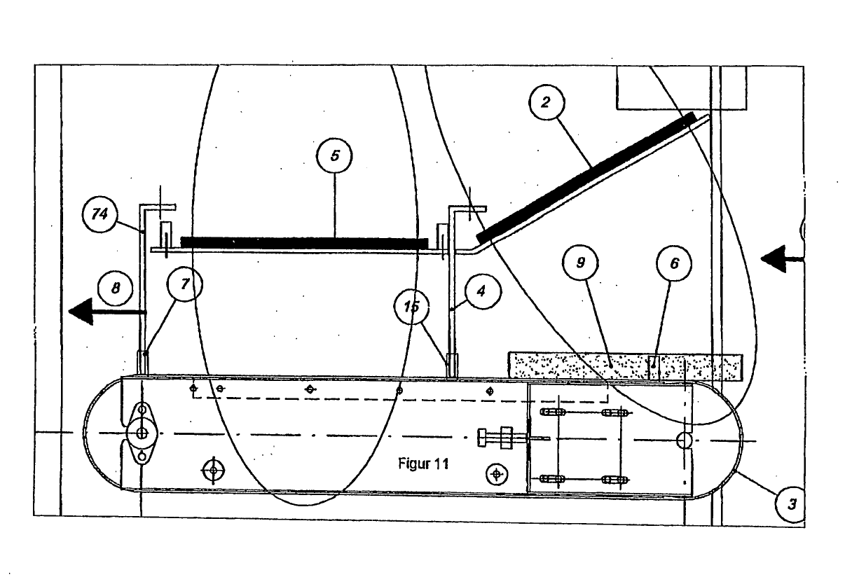

FIG. 11 a further embodiment variant of the arrangement according to the invention,

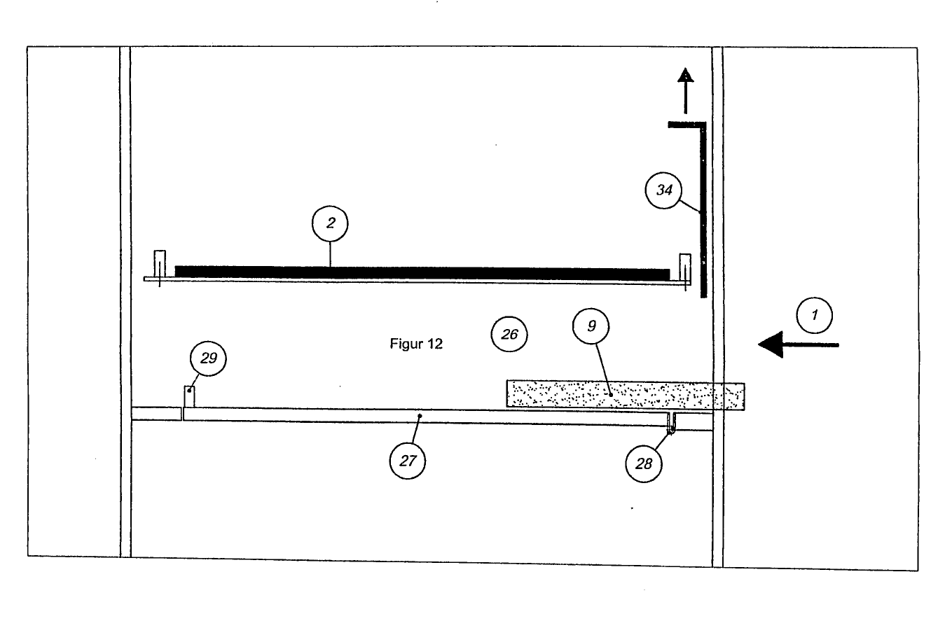

FIG. 12 schematically in section a facility for the prevention of impermissible manipulations and forwarding of an accepted object,

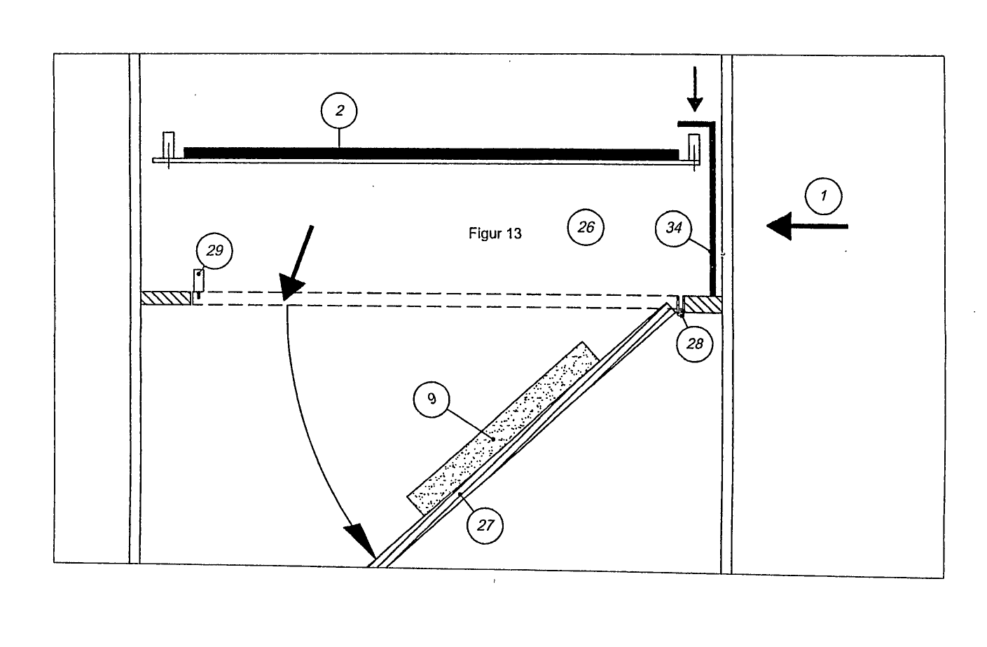

FIG. 13 the arrangement according to FIG. 12, representing schematically the further transport of the accepted object,

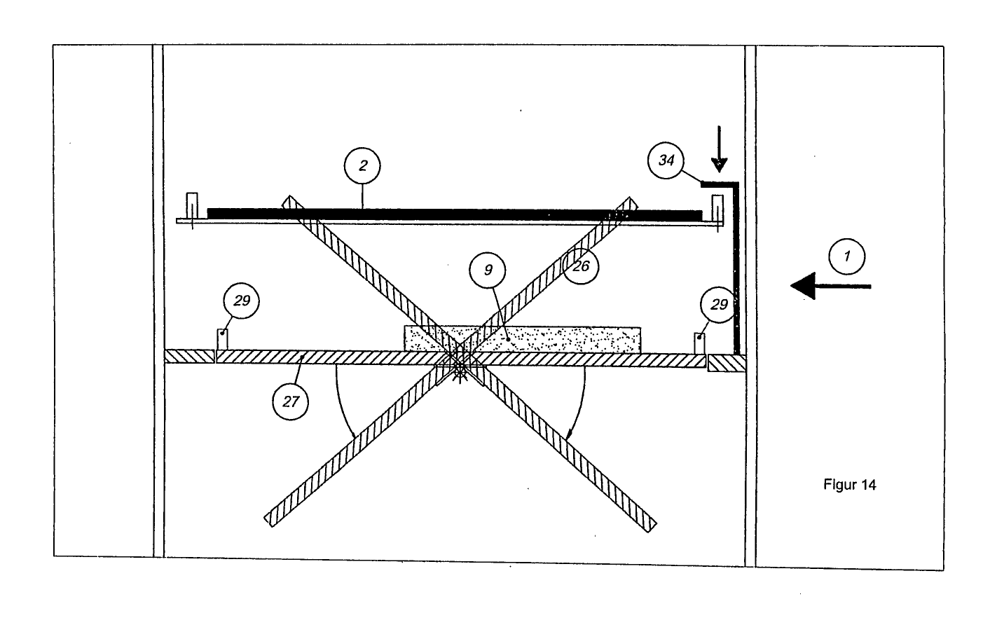

FIG. 14 analogous to FIGS. 12 and 13 a further embodiment variant of an arrangement to prevent impermissible manipulation and for the forwarding an accepted object,

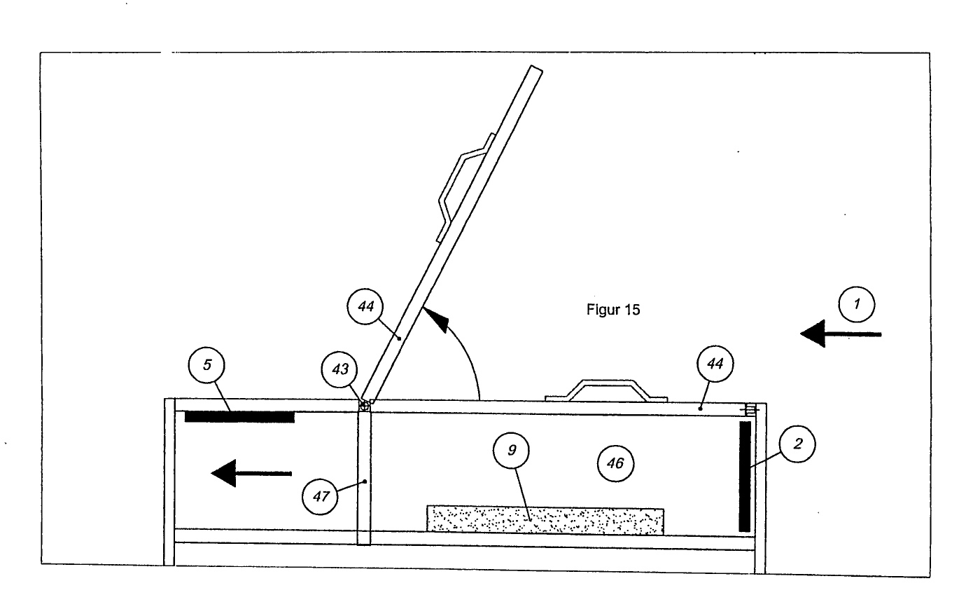

FIG. 15 schematically in section a further embodiment variant of the arrangement according to the invention implemented as a lock chamber,

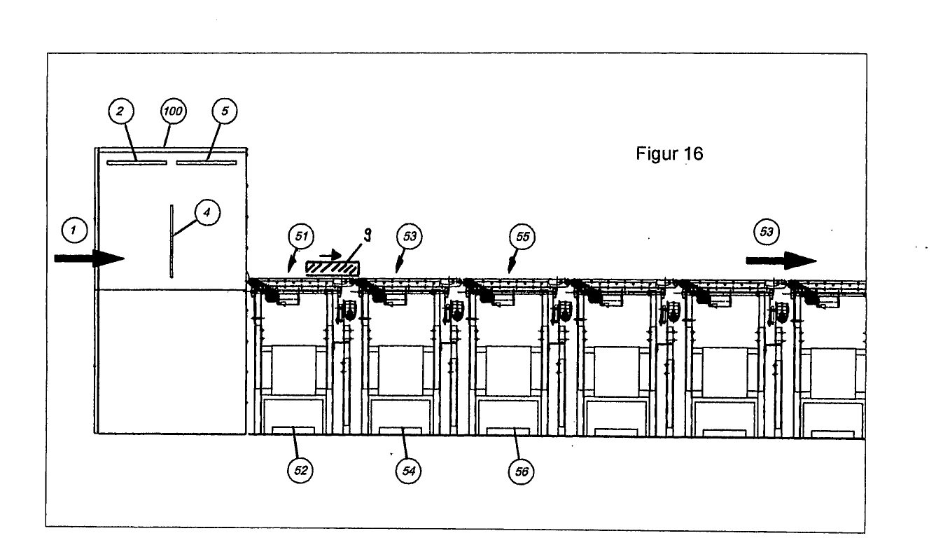

FIG. 16 schematically in longitudinal section a further embodiment variant of an acceptance arrangement comprising a sorting facility for sorting the accepted objects,

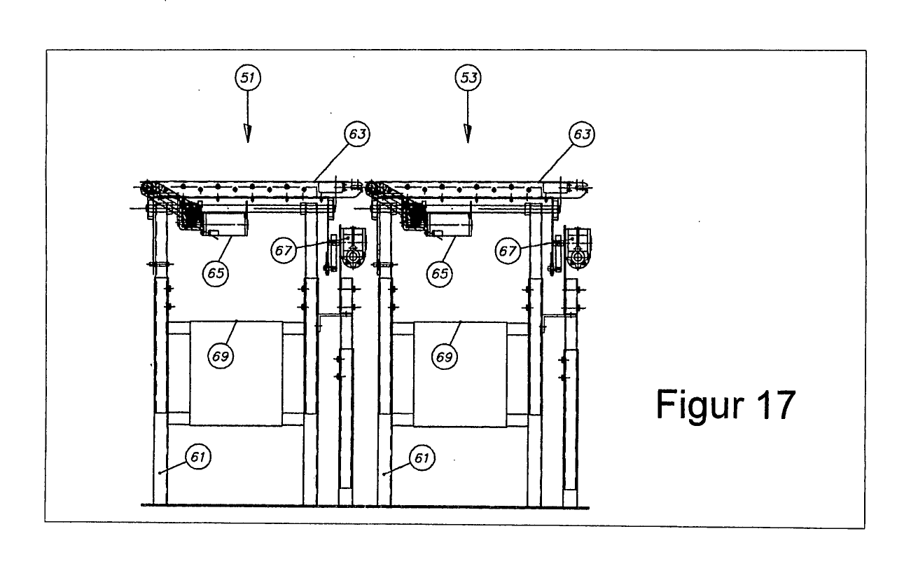

FIG. 17 in a cutout from FIG. 16 and from the sorting facility two tilt sorters disposed one behind the other at an enlarged scale, and

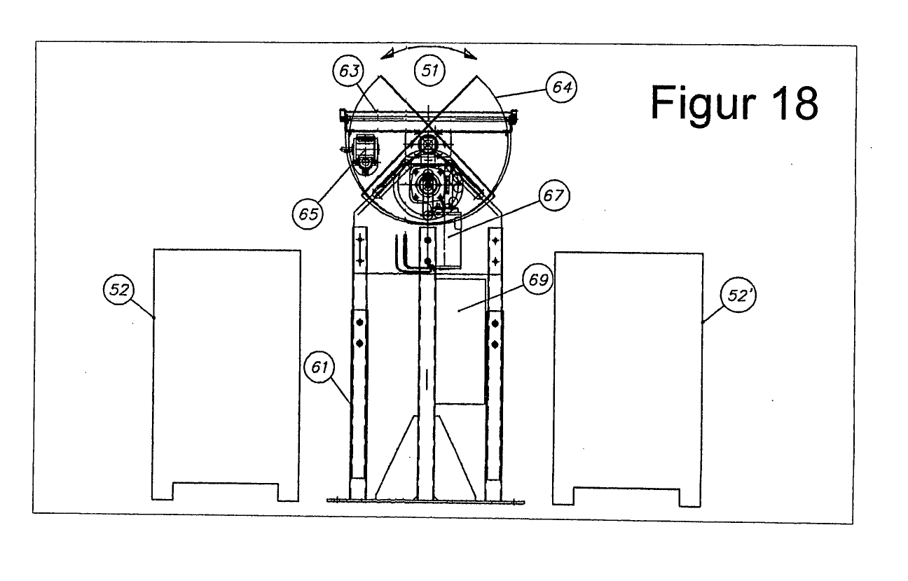

FIG. 18 a tilt sorter according to FIG. 17 in cross section.

The arrangement according to the invention is so laid out that exclusively only objects that are authorized to be accepted are accepted and that objects cannot be taken back again through manipulation by customers or users after the object has already been registered and, for example, a receipt has already been printed. The arrangement is intended to be employed for objects of deposit redemption systems and lending systems, which are provided with read-only RFID tags, as well as also for such objects provided with an RFID tag with at least one rewritable field, which describes, for example, the status of objects, such as “redeemable”, “no longer redeemable”; “shelved in the library” or “checked out”, etc.

According to the invention therefore an arrangement or an acceptance module according to FIG. 1 is proposed. Here an object 9 is guided into an intake opening 1. The object is detected by interrogator 2. If the object 9 is identified as being return-authorized, a conveyor belt 3 starts and a door 4 opens in order for the object to be conveyed past the door 4.

The object according to FIG. 2 now moves on the conveyor belt in the direction of the arrow and passes through the door 4 and is detected by interrogator 5. Interrogator 5 now changes the content, if available, of an information field on the RFID tag in order to record that the object has been accepted. This is carried out in order to prevent improper action. If the RFID tag does not include such an information cell, the invention preferably proposes instead that for each accepted object the identification number of the object is stored on a list and this number is blocked for acceptance for an appropriate length of time. This blocking may only concern the corresponding acceptance apparatus or advantageously a group of acceptance apparatus, which jointly manage a blocking list via data exchange. For example, in the presence of several parallel acceptance stations, it is in this way ensured that an object removed again at a station through improper manipulation can be entered at a parallel acceptance station in order to trigger its renewed registration. For lent objects in libraries a blocking time of 24 hours appears to be reasonable. For reusable objects (such as for example bottles, containers, packing drums, etc.) a longer blocking time of approximately 14 days appears reasonable. These times are naturally dependent on the expected circulating speed of the type of object and must be defined accordingly.

In the acceptance the data, or portions thereof, stored on the RFID tag (for example identification number, designation, etc.), are recorded by the computer for the subsequent receipt printout and for potential statistics.

When the object according to FIG. 3 has completely passed through the door 4, in a first embodiment the door 4 closes immediately if no new return-authorized object is detected by the interrogator 2. If no new object is detected, a receipt is printed. If a new object is identified at the intake, the above described process is repeated until all objects with return authorization have been entered by the user. Only then is the receipt printed.

In a second embodiment the door 4 always closes after an object has passed through the door 4, independently of whether or not a new return-authorized object is detected by interrogator 2. After a certain delay time, the door is again opened. This sequence reduces the intake rate compared to the first embodiment, but it has the advantage that between the accepted objects a minimum interval is ensured, which simplifies or makes possible the automatic sorting of the accepted objects.

Preferred is the variant with position sensor(s) 6 at the intake 1 (in front of door 4), such that the door 4 is only opened when the interrogator 2 detects an object that is return-authorized and the position sensor(s) 6 additionally indicates that an object is located in the opening 1 or is being entered. For the sequence control it is important to know whether the object is in front of, beneath or behind door 4. It is simultaneously important to secure the door such that it does not close should a person insert a hand.

This Function is Attained Inter Alia with a Preferred Variant:

A position sensor 15 can according to FIG. 4 monitor the door 4. According to FIG. 4 the position sensor 15, comprised for example of a photoemitter 11, a detector 12 and a light beam 13, can be disposed close under the conveyor belt 3, either immediately before, immediately after the door 4 or directly in the proximity of the door. In the last case the closing movement of door 4 starts immediately when the light beam 13 is no longer interrupted. In the normal case this means that the entered object 9 has passed through door 4. If the light beam 13 is interrupted, an object of some type is located under door 4 and the door 4 must not close further until the interruption of the light beam is again revoked. If the light beam 13 is interrupted longer than for a specified time, the belt 3 can be stopped or reversed in order to ensure that a person cannot be injured through the closing movement of door 4. With this variant the movement sequence of objects 9 can be tracked well. For example the door 4 can be closed again if, in spite of the detection of an object by the interrogator 2 and sensor 6 within a certain time no object arrives at the sensor 15. It is also possible to measure the length of time an object interrupts the light beam 13 and in this way, based on the belt speed, conclusions can be drawn regarding the object's length and possible manipulation attempts. Comment: placing of the position sensor following the door is less favorable since in this case theoretically an object can be located directly under the door without this being detected by the position sensor.

The safety of persons can be further increased by securing the door 4 separately, for example by employing pressure transducers, through a sliding coupling at the door drive or through a current limiter on the driving motor. It is also possible to integrate the position sensor into the door itself, according to FIG. 10.

Preferred is in any event an embodiment of the door 4 according to FIG. 5, which is difficult to open when force is exerted from the outside. For this purpose a latching means 20 is provided which, as soon as the door is closed, is latched, for example, by means of a magnetic switch.

The door can also be a swivel door/flap with, for example, a latching means, which opens when an object is entered which is authorized for acceptance and closes again and is latched when the object has passed through the door.

Avoided should be the use of mounting parts with electrical properties which affect the electric fields generated by the interrogator antennas 2 and 5, and therefore change/impair the reading/writing properties. This is important in order to ensure optimum reading properties. The electric fields 20 and 21 of the antennas are described in FIG. 6. In this region thus materials should be avoided which can affect the electric fields. This means that synthetic material rollers should be preferred for the driving and deflection rollers, that the supporting plate for the belt is produced of wood or synthetic material, and that components, which substantially affect the electric field, are not placed within the described magnetic field.

In the following some possible cases of improper action or attempted fraud during the return of objects will be explained by example in further detail with reference to the figures.

Case A: if before the receipt is output (i.e. before the door 4 is closed) the entered object is pulled back by means of a string, this is registered by interrogator 2 and optionally also by position sensor 6 and 15. The acceptance transaction already completed is in this case reversed by the data processing unit and the operator does not receive a receipt. In this case the manipulation attempt is documented in the log of the automatic machine and recorded and an appropriate manipulation message is transmitted to the operator and/or the provider company.

Case B: if the operator while entering the nth object attempts to pull back the n-1 previously entered objects by means of a string, the backward movement is also detected by interrogator 2 and 5, optionally also by position sensor 6 and 15. In this case the acceptance transaction is reversed and the operator does not receive a receipt. In this case the manipulation attempt is documented and recorded in the log of the automatic machine and a relevant message is transmitted to the operator and/or the provider.

Case C: If the manipulator first enters n-1 objects, which can be pulled back with a string and for which a receipt has been printed, and subsequently by means of an nth object that is authorized for acceptance ensures that the conveyor belt starts and the door 4 opens, the operator can possibly pull back the previously input n-i objects. However, this pulling-back is detected by interrogator 2 and 5 and optionally by the position sensor 6 and 15. In this case a theft alarm is triggered and the door 4 is closed as fast as possible if it is clear (this is checked by position sensor 15).

In order to impede/prevent theft attempts according to case C, it is proposed that door 4 is only open as long as absolutely necessary. According to the second embodiment variant the door 4 is closed immediately when the light path 13 is interrupted, and, according to the first embodiment variant, if no additional further acceptance-authorized objects are at the intake. Door 4 is closed, in addition, without consideration of the presence of further acceptance-authorized objects, if a theft attempt is detected by the system.

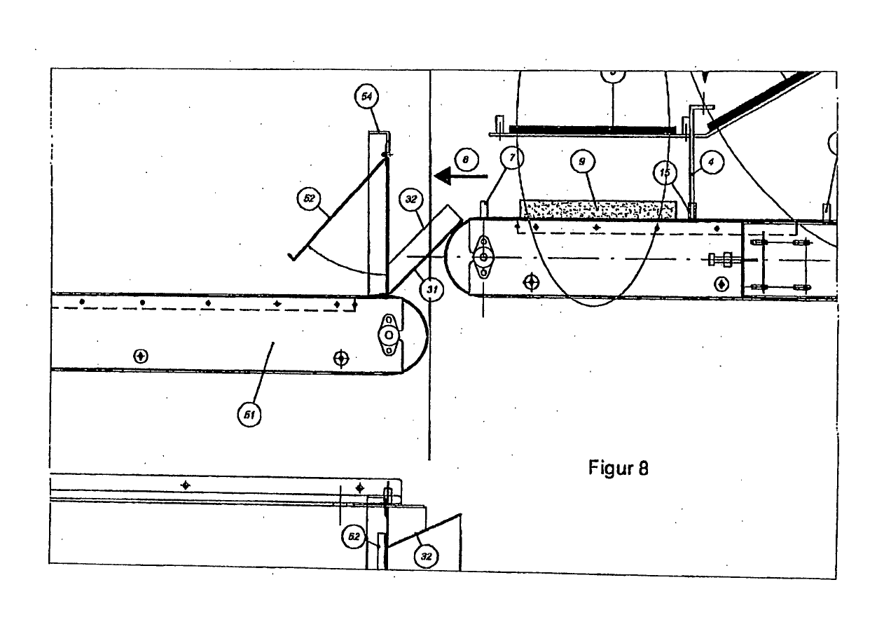

An alarm to the provider is immediately generated if the light path 13 is interrupted for a longer time than time Y. Time Y can be calculated with the aid of the maximum length of an object and the transporting rate of the conveyor belt. The door 4 closes (provided this is possible) immediately, if a backward movement is detected by any one of the interrogators or position sensors. Accordingly it is proposed that at the discharge 8 is mounted a position sensor 7 which detects the backward movement first. It is not necessary for the position sensor 7 to be mounted on the automatic machine itself, but can also be mounted in connection with the inlet into a collecting container, a sorting facility or conveying facility. In addition it is proposed according to FIGS. 7 and 8 that a mechanical configuration is employed, which makes pulling back the objects, which have left the conveyor belt 3, impossible or at least strongly impedes it. This is illustrated in conjunction with object 9, which slides on a slide 31 with guides 32, and either, according to FIG. 8, is transferred onto a conveyor belt 51 or, according to FIG. 7, is entered into a collecting container 41. The concept according to FIGS. 7 and 8 is that the object must pass through a flap 52, which is implemented such that it can only open in one direction and specifically at minimal pressure. This means that an object 9 which has passed through the flap 52 and is pulled back with a string abuts the flap 52 and cannot be pulled back further. This flap can be disposed at several useful locations, such as for example according to FIG. 8, on a conveyor belt 51, fastened by a mounting frame 54, at a slide 31 or, according to FIG. 7, at the opening 43 of a cover 42 on a collecting container 41.

Pulling the object back from a collecting container 41 can alternatively also be so prevented that mechanical guides are disposed in the opening, which act like catch grips. During a pulling-back it is in this case improbable that the objects can be moved back again through the opening.

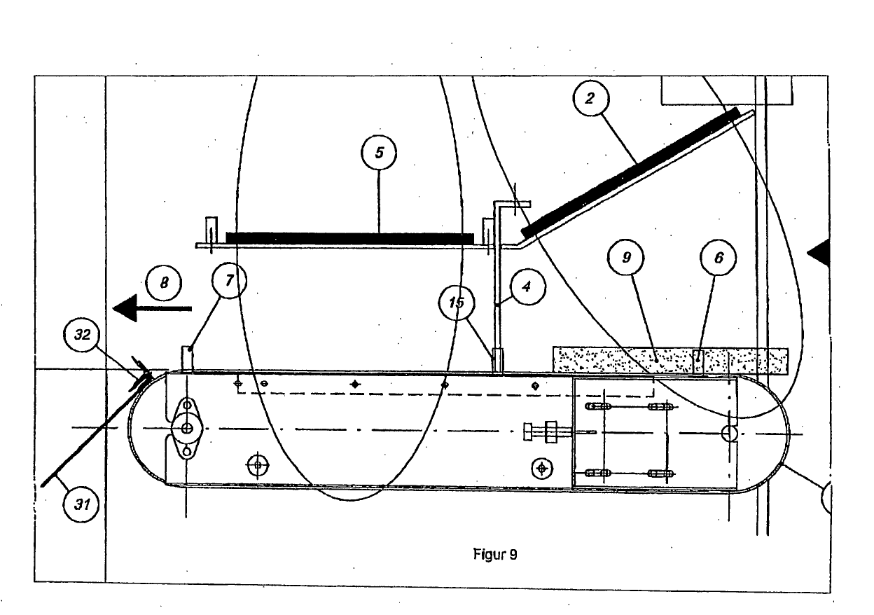

According to FIG. 9 it is additionally proposed that a cutter 32 is mounted on a slide 31, in order for a string to be cut during any pull-back. The cutter should preferably be spring-loaded, such that it yields under the weight of an object 9 and when unloaded returns to the original position, which corresponds to the optimum cutting angle. Cutters can be mounted where during an attempted pull-back of an object it can be assumed that a contact edge for the string is formed. An additional benefit of cutter 32 according to FIG. 9 is that the original position of the cutter in principle prevents a pull-back since, when an object is pulled back, it will abut the cutter in the process.

It is additionally proposed that the belt 3 is stopped or possibly moved in reverse if the sensor 15 is interrupted for longer than a certain length of time and the closing of the door is prevented by an article.

This invention has as its aim to refuse the acceptance of nonauthorized objects or optionally to return such an object immediately to the operator. If an object 9 is identified as acceptance-authorized by interrogator 2 and the position sensor 6 confirms the intake, the door 4 opens and an object can be transported past the door 4. Should it be found that through operator manipulation an object, which is NOT authorized to be accepted, is transported, this is ascertained after the object has completely moved through the door 4 and the interrogator 5 does not view the object read at interrogator 2. In this case the belt runs only forward until possibly present other objects in the system have left the belt. This is ascertained by the position sensors and/or by the interrogator 5. The belt 3 is subsequently reversed and said object is transported back to the intake 1. Door 4 closes as soon as the object has been transported past it. The belt stops if the object is so positioned on the belt that it is readily possible for the customer to remove it or take it back. This is checked by the position sensor 6. On the screen or another useful display the customer is prompted to remove the object from the intake.

In a further variant according to FIG. 11 a door 74 in an embodiment analogous to door 4 is also mounted at the discharge. The distance between the doors is at least as large as the length of the largest acceptance-authorized object. The concept is that at least one of the doors 4 or 74 is always closed. In this manner a lock is realized, which prevents any type of manipulation. The process is as follows: door 4 opens when an object 9 is identified at the intake 1 as being authorized to be returned and closes when the object has been transported past the door 4. The interrogator 5 registers the transaction and opens the door 74 in order for the object to be discharged. As soon as the object has been successfully discharged, the door 74 closes immediately. As soon as this closing is successfully completed, the door 4 is enabled to open again. In the event an object that is not acceptance-authorized has passed through door 4, this is detected in the clock by interrogator 5, belt 3 is reversed and door 4 is opened again in order to return the object again to the customer.

In FIG. 12 according to a further embodiment variant of the arrangement according to the invention it is proposed that already at the intake opening 1 a reclosable door 34 is disposed, through which the object 9 is entered into an intake zone. The object 9 is now located on a swivelable slide 27, which is fastened, for example, on hinge 28.

FIG. 13 shows the same arrangement as FIG. 12 and the further processing and transporting sequence for object 9 is shown schematically. The user now closes the door 34 such that the intake opening 1 is closed. Door 34 is latched. The interrogator 2 now reads the object 9 and, if it is authorized to be accepted or it is detected as pertaining to the lending system, the following actions are triggered. Slide 27 is swiveled downwardly, for example by means of a motor, such that the object 9 drops into a collecting container or onto a transporting/sorting system. When slide 27 is clear again, it is immediately swiveled up again and brought into the original condition. This can be ascertained by a limit switch 29. The repositioning triggers the latching means of the door 34 to be detached and the door can be opened again. The door can be fully- or semi-automatically or manually operatable. In every case it is advisable to indicate by signaling to the user when a new object can be, introduced and when the door can be opened again or when it will be closed.

It is understood that the swivelable slide according to FIGS. 12 and 13 can be realized in diverse variants. The hinge can be mounted for example on four possible sides, the slide can be divided into two swivelable flaps with two opposite hinges. Or, as depicted in FIG. 14, the swivelable slide can rock back and forth for example about a centrally disposed axis such that the capability is given of swiveling the slide in two directions. In this way identified objects can be sorted into the one or the other direction based on the identity.

FIG. 15 shows a further embodiment variant of the arrangement according to the invention similar to that depicted in FIG. 11, in that first the object is entered into a lock-like chamber 46 through the intake opening 1 by folding open a first flap 44 swivelable about an axis 43. The flap 44 is subsequently firmly latched and the object 9 placed into the chamber 46 is detected by interrogator 2. If the object 9 is detected as being redeemable or pertaining to the lending system, a second door 47 again, for example, swivelable about axis 43, is opened, such that the object 9 can be transported further from the lock-like chamber 46 in the direction of the arrow. Through the further interrogator 5 now the identification or further processing of the RFID tag on object 9 can take place. It is understood that it is also possible to dispose interrogator 5, and optionally a writing device, in the proximity of chamber 46.

The objects accepted back by an automatic acceptance machine or an acceptance station are often to be sorted, for example according to material, color, type, association or any other criteria. The goal is therefore to ascertain the way in which each object is to be sorted in order to carry out the sorting subsequently. FIG. 16 depicts schematically in longitudinal section such a sorting facility, which is suitable for separating the accepted objects or to supply them to separate receptacles. Again, via an intake 1 an object is entered into an acceptance station 100, where it is detected or acquired by interrogator 2 and optionally 5. By interrogator 2 and/or 5 can also, for example, be acquired information about an intended sorting, which is stored for example on an RFID label. On it can be contained for example information about whether the object is a book, a CD, a video, etc. In the automatic acceptance machine can be provided an assignment table, which indicates the location to which the various objects are to be transported or the way in which they are to be sorted, such as for example books in a container 52, CDs in a container 54, and videos in a container 56.

It is however also conceivable that sorting information or requirements are called up from an external server with a data base, such as a library server. This has the advantage that, for example, reserved books can be sorted out separately and be delivered to a special receptacle. It is also conceivable that the information from an RFID label as well as also from an external server is utilized in order to define the sorting path.

If, for example, the unambiguous determination of the sorting or of the sorting path takes place by means of an assignment table in the automatic acceptance machine, the object can subsequently, for example as was the case with reference to the preceding figure, pass through the defined door 4 in order to steer toward a so-called sorting facility with one or several sorting paths. Utilizing an assignment table is a cost-effective and efficient method since the sorting information needs to be acquired, checked and processed only once for each object.

As depicted in FIG. 16, the sorting facility comprises several sorting units 51, 53, 55, each with two or more sorting paths. Since the sorting facility is electrically and/or logically connected with the intake station or the interrogator 2 and/or 5, the corresponding sorting path can be automatically activated when the particular object has reached the corresponding sorting unit or the corresponding sorting path, respectively.

Acquiring the position of the object for the purpose of correct sorting can take place by means of various types of sensors.

It is, for example, possible to utilize the acquisition by means of an interrogator at each sorting unit 51, 53, 55, etc., in order to verify the position of the object. However, this can possibly be unnecessarily expensive and the position can perhaps not be acquired precisely since the RFID label may be affixed at an arbitrary place on the object. For this reason, according to a further embodiment variant it is proposed to determine the position of the object through the sorting facility up to the sorting path by means of light sensors and/or with position encoders, the encoder being disposed for example on the driving motor or the driving motors of the sorting facility or the sorting unit, respectively. For example, at each sorting unit a light sensor can be disposed, such as for example an optical waveguide apparatus of type FVDK 10P83Y0 with a simplex optical waveguide by Baumer Electric AG or a photoelectric cell, such as for example of type FPDK 14P5101/S35A by Baumer Electric AG, provided for the purpose of detecting the position of the particular objects. It is additionally proposed that the motor driving gear of the entire sorting facility, or optionally at each individual sorting unit, is equipped with position encoders, such that the positions of the objects on the belt are known at all times. The objects can subsequently be sorted out by means of pivot arms, guides, such as skirts, etc., lever arms or special driving mechanism, in order to be guided for example into the particular collection receptacle. If the object is not assigned to any of these sorting paths, it is simply transported further on the conveyor belt.

In FIGS. 17 and 18 a preferred embodiment variant of a sorting facility or a sorting unit is depicted. FIG. 17 shows two sorting units 51 and 53, arranged one behind the other, corresponding to the first two sorting sites according to FIG. 16. These are here so-called cascading tilt sorter units, i.e. they are disposed one behind the other in succession. The tilt sorters are electrically and/or logically connected with one another and, of course, also with the automatic acceptance machine, which, as depicted in FIG. 17, drives the tilt sorters 51 and 53, respectively, or communicates with them. The connection between tilt sorter and automatic acceptance machine can optionally also take place wirelessly, such as for example by means of a so-called WLAN connection. Each tilt sorter transports the object in the normal position by means of a moving belt 63 further to the next tilt sorter if the object is not assigned to this sorting unit. If a specific object has reached that tilt sorter to which it is assigned, the object is tilted by a swivel mechanism either to the right or the left depending on the specified sorting path. The operational function of the tilt sorter proposed according to the invention will be explained in further detail in conjunction with the two FIGS. 17 and 18, FIG. 18 showing the sorting unit 51 in cross section. When the object to be tilted off is located on the sorting unit 51, the conveyor belt 63, which is a component of the tilting unit 64, is swiveled by means of a tilting motor 67 either to the left or the right such that the object slides either into receptacle 52 or receptacle 52′.

The conveyor belt 63 is preferably stopped by switching off the driving motor 65 and the angle of inclination must be large enough in order to ensure that the object slides off into the provided receptacle 52 or receptacle 52′. After the object has slid off, the tilting unit 64 is again swiveled back in order to swivel the transporting belt 63 again into the transporting plane. This plane can be horizontal or also minimally inclined depending on the objects to be transported, the requirements made of the transport, etc. The control of the tilting unit can be accommodated for example in a control box 69, which, together with the tilting and transporting mechanism, is supported or held on a mounting stand 61. The optical waveguides are advantageously mounted at the front and/or the back on the tilt sorter. The precise position of the object on the belt can moreover be tracked if, additionally, a position encoder is employed on the moving belt motor 65. In order for the belt to return after the swiveling to the horizontal or the desired operating inclination, the swivel motor is advantageously also equipped with a position encoder.

In order for the optimum position of the object at the tilt sorter to be attained when it is swiveled out, for example in order optimally to fill a sorting container 52 or 52′, respectively, the length of the object is advantageously acquired in the acceptance site 100. This length can be determined for example thereby that the traversed distance is acquired during which the object interrupts for example a light beam 13 (FIG. 4). This interruption yields the longitudinal extent of the object. The longitudinal extent determined in this way is subsequently transmitted to the sorting unit.

By means of the particular optical waveguide disposed at the corresponding sorting unit and the position decoder of the driving motor the position determination can be carried out at the particular sorting unit, i.e. based on the acquired length it is possible to determine precisely at which position of the particular sorting unit the object is to be carried away. It thereby becomes possible to tilt away into one and the same container, for example at one end, small books and, at the other end, large books.

The control of the individual sorting units can take place centrally thereby that the individual sorting units are addressed directly by the acceptance arrangement. Stated differently, position sensors monitor the sequence of movements of each individual object on the sorting facility and make the information available to the acceptance arrangement, and that the acceptance arrangement triggers the action at each sorting unit directly, in order for the object entered or transported along the sorting device to be processed correctly, such as, for example, tilted to the right, left, delivered to the next sorting unit, etc.

However, it is also possible that the individual sorting units are equipped with more intelligent control, such that they can assume and master tasks independently or autonomously. In contrast to a central control, consequently in this case a local control or a local mode, respectively, is involved here. The acceptance arrangement or the interrogators 2 and/or 5, respectively, or the sensor 6 can transmit for example sorting information relating to object 9 to the first sorting unit 51 when the object 9 arrives at this unit. This information can comprise for example: sorting to the left at sorting unit 55, object length 30 cm, etc. Based on this sorting information, the sorting unit 51 recognizes independently what should be done with the object, respectively what must take place at this sorting unit. According to said examples, the object is transported further to the succeeding sorting unit 53, the sorting information being transferred to this unit. Sorting unit 53 analogously transports object 9 further to sorting unit 55 and transmits to it also the corresponding sorting information. At the sorting unit 55 or sorter 55, left-sorting is triggered as soon as the object 9 has assumed the correct position at this unit.

Between said modi, such as central and local modus, every conceivable intermediate solution is possible. For example it is conceivable that the acceptance arrangement transmits sorting information not only to the first sorting unit but to all connected sorting units. By means of information about the movement progression, which the sorting units exchange among each other, the sorting units can, autonomously by themselves or as a whole, ensure the correct or specified action.

As already discussed the sorting units can be connected by cable to one another as well as also with the acceptance arrangements, such as in particular to interrogators 2 and/or 5 and/or to the sensor 6, or a wireless connection can be utilized, such as for example a WLAN (Wireless Local Area Network). A plurality of cabling and/or protocols can be employed. One option is to equip the acceptance arrangement with a microprocessors card, which, for driving the tilt sorter, is connected across a serial RS232 connection and/or a so-called CAN bus with the microprocessors. It should furthermore be stated that it is understood that in an acceptance arrangement according to the invention with said sorting units the logic/control components or the microprocessor(s), connected therewith and driving the arrangement, can also be disposed outside the acceptance arrangement or the housing.

It is understood that the arrangements depicted in FIGS. 1 to 18 are only examples serving for the purpose of explaining the present invention in greater detail. It is, of course, possible to modify the arrangement in any desired way, to adapt it, to supplement it with additional elements, etc. It is, for example, also possible to employ the arrangement for the simultaneous acceptance of several redeemable object or lent objects. Again, several objects, for example provided with an RFID label, are placed on a transporting belt at the acceptance and moved past the first read apparatus. Through the reading apparatus, such as for example interrogator 2, again the codes or the labels are read and it is ascertained how many of the entered objects are authorized to be returned or pertain to the deposit redemption or lending system. The number of objects whose codes or labels meet the requirements is, for example, output on a display and the user or the consumer can check whether or not the number detected by the interrogator agrees with his assumptions. If it does, he can confirm the detected number and the acceptance process is continued as described above with reference to several figures. However, if the assumption by the consumer or user does not agree with the displayed number, he has the option of not confirming the acceptance, whereupon all objects, for example a bottle crate, must be removed from the system and the transporting mechanism is not even set into operation or the crate is returned to be consumer.

Should it be necessary to ascertain or to verify whether an object entered into the acceptance station is authorized to be accepted or whether for the determination of the sorting path data are to be obtained from outside the acceptance station, for example from an external data base, the acceptance speed of the acceptance installation can be significantly impaired. The acceptance station must in this case obtain information for each individual returned object from the data base of an external server and interpret this information. In the event of poor response times, for example in the EDP network or in the Internet, can lead to unreasonable waiting times for the customer.

For this case, it is further proposed according to the invention to define a so-called off-line mode, i.e. that the customer can enter objects at intake 1, without an external data base being checked after the acquisition by interrogator 2. Only later, after the customer has been served, matching against the external data base is performed. However, now the risk is encountered that objects which are not authorized to be accepted, such as for example books from a different library or receptacles which are not within the redemption system, are accepted and/or that sorting is not possible due to lacking sorting information. For this reason in order to ensure better and more reliable functioning in said off-line mode, it is proposed that periodically, for example once or twice daily, information is downloaded onto the particular automatic acceptance machine or the specific return station, respectively, from an external data base regarding all objects in the system or, alternatively, all objects lent or released. Thus in off-line mode access can be had to the locally stored data base in the acceptance station and, optionally, it is possible to verify virtually instantaneously whether an object is authorized to be accepted, how the sorting is to be carried out, the title of the book, etc. The completed return transaction, however, should as soon as possible after completed acceptance and serving of the customer, be matched against the external data base in order for the external server to be always as updated as possible and the personnel can provide the correct information such as, for example, about the availability of individual objects. An example of such a library information system with an external data base defined such is the SISIS system, which libraries can obtain and apply from Sisis Informationsysteme GmbH (www.sisis.de).

The so-called redeemable objects involve not necessarily reusable articles but the arrangement described according to the invention is also suitable for single-use objects which, for example, for reasons of environmental protection, should be returned to a suitable site. With the arrangement or the method defined according to the invention it is also possible to prevent, due to the introduction of waste disposal fees, disposing improperly and carelessly articles no longer needed. Based on a charged deposit it is always worthwhile to return an object to the appropriate collecting site, such as for example to an arrangement according to the invention provided for the acceptance of such objects and intended for this purpose, instead of disposing of it improperly. For example, when purchasing a television set a deposit can be charged, which is at least partially paid back if the television set is returned to the corresponding site provided for this purpose and is disposed of once the television set is no longer used.

It is further conceivable that upon the acceptance of objects not a specific amount is paid or credited, but that simultaneously the option is provided of crediting the deposit directly to a charitable institution or as a wager in a game of chance.

It is also possible upon the simultaneous return of ten or a number of objects to pay an additional bonus, for example a loyalty coupon. Furthermore, at the acceptance station for example a keyboard can be provided, with which the consumer can enter the way in which the deposit is to be paid or to be used.

Expressed differently, the present invention is not limited to a specific object or type of redemption or lending, but rather it can be applied wherever an unambiguous identification or designation of an object that is to be returned or has been returned is necessary or the return, proper disposal or recycling of a delivered object is desirable or reasonable or necessary.

It is also possible to give the user vouchers for certain products or to call attention to these products. These can relate to known behavior patterns of the user. For example it is known to gather often information about the buying habits or the book references of customers. Therewith, for example in a combined library/book store, attention can be drawn to books, which should meet the personal taste of customers and are available for purchase.

1. Arrangement for the acceptance or return of objects (9) for which a deposit has been paid or can be paid and/or of objects (9) pertaining to a lending system, at least provided with an at least readable identification code, characterized by
an acceptance zone (1) for the intake or positioning of the object (9) to be accepted,
a reading device (2) in order to ascertain the association of the object with a specific deposit or a lending system,
a transporting device (3) which is operationally connected with the reading device such that, after the object's association has been positively ascertained, it is transported further, as well as
at least one blocking member (4, 27) through which, upon positive ascertainment by the reading device, the object is transported.

2. Arrangement as claimed in claim 1, characterized in that at the blocking member (4, 27) means are provided, such as a latching element, automatic closing means or the like, in order to at least impede the backward movement of the object after its passage.

3. Arrangement as claimed in claim 1 characterized in that at the blocking member (4, 27) monitoring means (15), such as light barriers, pressure transducers, position sensors, etc., are provided in order to control the blocking member (4, 27) and to detect the backward movement of the object.

4. Arrangement as claimed in claim 1, characterized in that the at least one blocking member (4, 27) comprises a swivel element, whose swivel action can only be actuated in the direction of transport and not in the opposite transport direction.

5. Arrangement as claimed in claim 1, characterized in that further an identification sensor (5) is provided in order to identify the accepted object (9) and, in the case of a redeemable object, to acquire the appropriate amount of redemption or, in the case of a lending system, to register the acceptance of the object and optionally the object itself.

6. Arrangement as claimed in claim 5, characterized in that the identification sensor and the reading device are identical or are accommodated in one and the same structural component.

7. Arrangement as claimed in claim 1, characterized in that the reading device (2) is disposed, in the direction of transport of the transporting device, in front of the blocking member (4) and the identification sensor (5), succeeding the blocking member.

8. Arrangement as claimed in claim 1, characterized in that the monitoring means (15) in the proximity of the blocking member (4) comprises at least one position sensor, such as a light barrier or a pressure transducer, etc., which indicates whether or not an object is located in the proximity of the blocking member, and which optionally detects further whether the object has stopped or is moved backward.

9. Arrangement as claimed in claim 5, characterized in that the identification sensor (5) includes additionally a writing device in order to change optionally data on a rewritable code or label, such as an RFID tag disposed on an object, and/or to transmit data to this code or label.

10. Arrangement as claimed in claim 1, characterized in that the reading device (2) and the identification sensor (5), or optionally the writing device, read/acquire or transmit data in the radio frequency range.

11. Arrangement as claimed in claim 1, characterized in that in the proximity of the identification sensor (5) or, optionally succeeding in the direction of transport, a discharge zone for the identified or registered object is provided, in which discharge zone at least one further position sensor (11) is provided in order to detect the discharge of the object to a succeeding site or to ascertain a backward movement of an object.

12. Arrangement as claimed in claim 11, characterized in that in the discharge zone a further blocking member (74) is provided in order to detect or prevent a backward movement of the object.

13. Arrangement as claimed in claim 11, characterized in that in the discharge zone a cutting instrument (32) is provided which, during the transport of an object in the direction of the transporting device, can be folded or swiveled away and, in the event the object is transported in the opposite direction, is activatable for example by means of a spring, in order to sever removal aids, such as strings, cords and the like, employed to transport the object in the opposite direction.

14. Arrangement as claimed in claim 1, characterized in that an alarm signaling device is provided which is activatable in the event of improper use of the arrangement.

15. Arrangement as claimed in claim 1, characterized in that at least two blocking members (4, 74) are provided which are operationally connected with one another such that, in the manner of a lock, one of the two blocking members is always latched or is closed to the passage of an object.

16. Arrangement as claimed in claim 1, characterized in that in the acceptance zone for the intake or positioning of the object (9) to be accepted an additional blocking member (34) is provided, and in the proximity of the reading device (2) and optionally of the identification sensor (5), respectively, a downwardly swivelable base (27), such as for example a swivelable slide, is provided which is implemented such that, upon a positive ascertainment by the reading device, it can be unlatched and swiveled downwardly.

17. Arrangement as claimed in claim 16, characterized in that the additional blocking member (34) disposed in the acceptance zone is operationally connected with the downwardly swivelable base such that, when the base is folded down, the further blocking member is closed or latched.

18. Arrangement as claimed in one of claims 1 or claim 1, characterized in that the arrangement comprises a lock-like chamber (46), into which the object (9) to be detected can be placed and in which the object can be identified by means of the reading device (2), and that at the lock-like chamber (46) at least two reclosable chamber walls or blocking members (44, 47) are disposed, which are operationally connected with one another such that at least one blocking member is always closed, and that upon a positive ascertainment or recognition of the object by the reading device (2) the blocking member (47) succeeding the lock-like chamber (46) can be unlatched in order to make possible the further transport of the object (9), which optionally can be identified by the identification sensor (5).

19. Arrangement as claimed in claim 1, characterized in that adjoining the acceptance zone (1) a sorting device is provided comprising one or several sorting units (51, 53, 55) in order to sort the accepted objects.

20. Arrangement as claimed in claim 19, characterized in that the sorting facility comprises sorting units (51, 53, 55) largely operating autonomously, each comprising a transporting belt (63), preferably each driven by a driving motor (65), with at least one sensor being assigned to each sorting zone for acquiring the object and optionally its position, and preferably each sensor and/or a sorting unit control being electrically and/or logically, optionally wirelessly, for example by means of WLAN (Wireless Local Area Network), connected at least with the acceptance arrangement or with its one reading device (2) and/or an identification sensor (5).

21. Arrangement as claimed in claim 19, characterized in that preferably each sorting unit is provided with an RFID reader or interrogator and/or with at least one light sensor and/or one position encoder disposed on the particular driving motor of each sorting unit.

22. Arrangement as claimed in claim 19, characterized in that each sorting unit comprises at least one so-called tilt sorter unit, which, in the case of several units, are arrayed in series one after the other, i.e. placed in succession.

23. Arrangement as claimed in claim 22, characterized in that at each tilt sorter the particular conveyor belt, viewed in the direction of transport, is swivelable either to the left or to the right, such that an object disposed on the conveyor belt can be swiveled either to the left or the right, for example into a container or a receptacle (52, 52′).

24. Arrangement as claimed in claim 22, characterized in that the driving motor (65) of the particular conveyor belt (23) of each tilt sorter, as well as also a tilt motor (27) provided for tipping, are each provided or connected with a position encoder, in order to be able to acquire the position of the object on the belt and the particular swivel angle or reset angle to be selected, in order to swivel the conveyor belt back into the starting position.

25. Arrangement as claimed in claim 19, characterized in that in the acceptance zone (1), in addition to the reading device (2), an optical waveguide (11) and a position encoder are disposed at the transporting device (3) for acquiring the length of the returned object in order to transfer the measured length to a control at the particular sorting unit for the sorting or tilting in the correct position of the accepted object.

26. Arrangement as claimed in claim 19, characterized in that the sorting units (51, 53, 55) are logically and/or electronically connected with one another and with the acceptance arrangement, and consequently with the reading device (2), and the connection can take place by means of a CAN bus.

27. Arrangement as claimed in one of claims 1 to claim 1, characterized in that the acceptance arrangement, and consequently functionally also the sorting units, are provided with an external data base or a local data base, on which are stored the data relevant for the arrangement or acceptance station and/or those of lent or released objects.

28. Method for the acceptance or return of objects for which a deposit has been paid or can be paid and/or of objects pertaining to a lending system, at least provided with an at least readable identification code, characterized in that at an acceptance zone for the intake or positioning of the objects to be accepted by means of a reading device the association of an object to a specific deposit or lending system is ascertained, subsequently a transporting device, operationally connected with the reading device, upon the positive ascertainment of the association of the object, is activated in order to transport the object through a blocking member which, upon positive ascertainment by the reading device, is unlatched or opened for the through-transport of the object.

29. Method as claimed in claim 28 for the acceptance or return of several objects and/or one object containing several object units, characterized in that the reading device acquires the number of accepted or returned objects or object units and displays this number visually and/or acoustically, whereupon the person or the consumer entering the objects or units confirms the acquired number or rejects it, whereupon, in the event of rejection, the transport further or the processing further of the object and/or of the units is interrupted and/or the object or the units are returned to the person or the consumer.

30. Method as claimed in claim 28, characterized in that the accepted or returned object(s) are acquired based on the data exclusively identifying the particular object, such as serial number, identification code, etc. and these data are stored in a negative list, i.e. a list of items no longer authorized to be accepted, and these data are optionally matched or exchanged with another acceptance arrangement, the term of validity of the entries in the negative list being defined according to the particular application purpose.

31. Method as claimed in claim 1, characterized in that, in the case the object entered into the acceptance station is authorized to be accepted, for the verification, or for the definition of a subsequent sorting of the object, data must be called up from an external data base, to shorten the data call-up or, in the event of poor response times in an EDP network or if possibly temporarily no connection is available, the acceptance arrangement or the accepting zone can be operated in off-line mode in that information from the external data base regarding all objects acquired in the data base or, alternatively, all information regarding lent/released objects are periodically downloaded onto a local acceptance data base at the acceptance arrangement.

32. Method as claimed in claim 28, characterized in that the object(s) upon positive ascertainment by the reading device is transferred to a sorting device comprising one or several sorting units in order to sort the returned or accepted objects, and that the individual sorting units are driven by the acceptance arrangement or reading device such that a possible sorting action is triggered at the particular sorting unit in order to process or sort out the object to be sorted at the particular sorting unit.

33. Method as claimed in claim 28, characterized in that at least at one or at several sorting units an intelligent control is provided and that these sorting units are operated largely independently or autonomously, such that from the acceptance arrangement or the reading device sorting information regarding the object to be processed is transmitted to the sorting units, and, in conjunction with the sorting information, the object is independently processed or sorted at the particular sorting unit or transported further to a further sorting unit.

34. (canceled)

35. Sorting facility for sorting various objects, in particular suitable for an acceptance arrangement as claimed in claim 1, characterized by several, preferably largely autonomously operating sorting units (51, 53, 55) with at least two sorting paths for sorting out the objects, each sorting unit comprising at least one transporting belt (63), preferably driven by a driving motor (65), as well as one tilt sorter device for each sorting unit provided in order to tilt off the transporting belt, viewed in the direction of transport, to the left or to the right in order to tilt away, for example into a receptacle, an object located on the transporting belt to be sorted out at a specific sorting unit.

36. Sorting facility as claimed in claim 31 characterized in that to each sorting unit at least one sensor is assigned, which is preferably electrically and/or logically connected with a reading device and/or a further sensor in an intake zone of the sorting facility, and the sensor can be an identification sensor, such as for example a light sensor, an RFID reader or interrogator, as well as also a position encoder, disposed on the particular driving motor of the transporting belt of each sorting unit.
